(19) United States
(12) Patent Application Publication
(10) Pub. No.: US 2017/0045031 A1
(43) Pub. Date: Feb. 16, 2017

(54) NOISE REDUCTION MEANS FOR A ROTOR BLADE OF A WIND TURBINE

(71) Applicant: Siemens Aktiengesellschaft, München (DE)

(72) Inventors: MICHAEL J. ASHEIM, DENVER, CO (US); VALERIO LORENZONI, KEBENHAVN (DK); STEFAN OERLEMANS, HERNING (DK); ANDERS SMAERUP OLSEN, FREDERIKSBERG (DK); MANJINDER J. SINGH, BROOMFIELD, CO (US)

(21) Appl. No.: 15/124,694

(22) PCT Filed: Mar. 4, 2015
(86) PCT No.: PCT/EP2015/054496

§ 371 Date: Sep. 9, 2016

Related U.S. Application Data
(60) Provisional application No. 62/022,778, filed on Jul. 10, 2014.
(60) Provisional application No. 61/989,186, filed on May 6, 2014.

(51) Int. Cl. F03D 1/06

(52) U.S. Cl. CPC F03D 1/0633; F03D 1/0675; F05B 2240/30; F05B 2260/96

(57) ABSTRACT

A rotor blade of a wind turbine is provided. The rotor blade includes a pressure side, a suction side, a leading edge section, and a trailing edge section with a trailing edge. The rotor blade includes a noise reduction means with at least one aerodynamic device for manipulating an airflow flowing from the leading edge section to the trailing edge section. The airflow builds up a boundary layer with vortices adjacent to the surface of the rotor blade. The aerodynamic device is located at the trailing edge section of the rotor blade, and is arranged such that it is able to split up a vortex of the boundary layer into several smaller sub-vortices. Thus, noise that is generated by interaction of the airflow with the rotor blade may be reduced.

### CROSS-REFERENCE TO RELATED APPLICATIONS

This application claims priority to PCT Application No. PCT/EP2015/054496, having a filing date of Mar. 4, 2015 based off of U.S. Ser. No.: 62/022,778, having a filing date of Jul. 10, 2014, and U.S. Ser. No. 61/989,186, having a filing date of May 6, 2014, the entire contents of which are hereby incorporated by reference.

### FIELD OF TECHNOLOGY

The following relates to a rotor blade of a wind turbine. The rotor blade comprises a noise reduction means for reducing noise that is generated by interaction of the rotor blade and an airflow flowing from the leading edge section to the trailing edge section of the rotor blade.

### BACKGROUND

Noise arising from rotor blades of a wind turbine may become a critical factor when it comes to obtaining a permission to erect the wind turbine. This is particularly the case if the wind turbine shall be erected close to a residential area. Consequently, the wind turbine industry and research institutes are continuously searching for ways to reduce and mitigate noise that is generated by the wind turbine.

Noise that is generated by interaction of the rotor blades and the airflow flowing around the rotor blade significantly contributes to the overall noise that is generated by the wind turbine. Different ways to reduce the rotor blade related noise have been proposed in the past.

One option is the provision of serrated flaps that are attached to the trailing edge of the rotor blade. Another option to reduce the noise is an adapted design of the airfoil shape of the rotor blade, particularly at the trailing edge section of the rotor blade.

Despite these measures, there still exists the need and desire to further reduce noise that is generated by interaction of the rotor blade and airflow flowing around the rotor blade.

### SUMMARY

An aspect relates to a rotor blade of a wind turbine, wherein the rotor blade comprises a pressure side, a suction side, a leading edge section, and a trailing edge section. The trailing edge section comprises a trailing edge. The rotor blade comprises furthermore a noise reduction means with at least one aerodynamic device for manipulating an airflow flowing from the leading edge section to the trailing edge section of the rotor blade. The airflow builds up a boundary layer with vortices adjacent to the surface of the rotor blade. The aerodynamic device is located at the trailing edge section of the rotor blade. The aerodynamic device is arranged such that it is able to split up a vortex of the boundary layer into several smaller sub-vortices, thus noise that is generated by interaction of the airflow with the rotor blade is reduced.

A wind turbine refers to a device that can convert wind energy, i.e. kinetic energy from wind, into mechanical energy. The mechanical energy is subsequently used to generate electricity. A wind turbine is also denoted a wind power plant.

The rotor blade of a wind turbine has an airfoil shape in most sections of the rotor blade. Consequently, a pressure side, a suction side, a leading edge and a trailing edge can be attributed to the rotor blade. The area around the leading edge is referred to as the leading edge section. Likewise, the area around the trailing edge is referred to as the trailing edge section. When the rotor blade is in relative motion with regard to ambient air, i.e. the atmosphere, an airflow is flowing around the rotor blade. Specifically, for a rotating rotor blade of a wind turbine, an airflow flowing from the leading edge section to the trailing edge section exists.

In immediate proximity to the surface of the rotor blade, the velocity of the airflow approaches zero. With increasing distance from the surface of the rotor blade the velocity of the airflow increases until a value of the free stream velocity of the airflow is reached. The layer adjacent to the surface of the rotor blade where the velocity of the airflow is below 99 percent of the free stream velocity is referred to as the boundary layer. A typical thickness of the boundary layer at the trailing edge section of a rotor blade of 50 to 80 meters length amounts to a few centimeters. In other words, a typical thickness of the boundary layer is between 1 centimeter and 10 centimeters. The airflow in the boundary layer at least partially comprises turbulences. This implies that the airflow within the boundary layer comprises vortices. These vortices are also referred to as eddies. When these vortices reach an edge or a rim, such as the trailing edge, significant noise may be generated. In other words, the passage of the vortices by the trailing edge is a considerable source of noise emission at the rotor blades.

A key aspect of embodiments of the present invention is the provision of one or more aerodynamic devices upstream of the trailing edge of the rotor blade. These aerodynamic devices split up vortices of the boundary layer into several smaller sub-vortices. Thus, these aerodynamic devices act as breakers for the large vortices of the boundary layer. It is noted that the passage of the smaller vortices, which are also referred to as sub-vortices, at the trailing edge generate a different noise compared to the passage of the initial large vortices at the trailing edge. One difference is a shift of frequencies which can be attributed to the noise generated by the vortices at the trailing edge. In general, the sub-vortices have a set of higher frequencies. Thus, noise with higher frequencies is emitted and radiated from the trailing edge. When this high frequency noise is disseminated in the ambient air that surrounds the rotor blade, attenuation of these high frequencies is increased. Thus, a reduced noise reaches the listener which is situated in a certain position and at a certain distance away of the rotor blade. By this mechanism, the noise that is generated by the interaction of the rotor blade and the airflow flowing around the rotor blade may be considerably reduced.

Thus, a first advantage of the noise reduction means is that by splitting up, in other words by breaking up the vortices of the boundary layer into a plurality of smaller sub-vortices the frequencies of the noise that is generated at the trailing edge is shifted to higher frequencies. These higher frequencies are attenuated more efficiently in the ambient air around the rotor blade. Thus noise, which is audible at typical distances away of the wind turbine, is reduced.

Another advantage of the present noise reduction means is that the rotational direction, in other words the rotational axis of the sub-vortices may be influenced such that a further decrease of the generated noise may be achieved. If, for instance, the generated sub-vortices comprise a rotational axis that is parallel to the direction of the airflow at the trailing edge section a separation of the sub-vortices with regard to the surface of the rotor blade may be achieved. In other words, the sub-vortices are lifted above the surface of the rotor blade and pass by the trailing edge at an increased distance. By this distance from the trailing edge a further reduction of generated noise at the trailing edge can be achieved.

Note that in an advantageous embodiment of the present invention, a plurality of aerodynamic devices are provided which lead to a vortex sheet that is generated downstream of the aerodynamic devices and that this vortex sheet may displace the boundary layer from the surface of the rotor blade, in particular from the trailing edge where considerable scattering occurs.

In an advantageous embodiment of the invention, the rotor blade comprises a root section, where the rotor blade is arranged and prepared for being attached to a hub of the wind turbine. The rotor blade furthermore comprises a tip section, which is the section of the rotor blade that is furthest away of the root section. The aerodynamic device is connected to the rotor blade in the outer 40 percent, in particular in the outer 25 percent, of the rotor blade adjacent to the tip section.

In other words, it is advantageous to place the noise reduction means with the aerodynamic device in the outer part of the rotor blade. This is advantageous because a significant share of the overall noise that is generated by the interaction of the rotor blade and the airflow is generated at the outer part of the rotor blade. At the outer part of the rotor blade high wind speeds are present compared to the inner part of the rotor blade. Thus, a considerable fraction of the overall noise is generated by high speed airflow passing by the trailing edge in this region of the rotor blade.

In another advantageous embodiment, the aerodynamic device is located inside the boundary layer of the airflow.

This has the advantage that drag which may be caused by the aerodynamic device is minimized. Measurements and investigations by the inventors have been shown that an aerodynamic device that is entirely submerged in the boundary layer nearly causes no additional drag if the rotor blade is operated in a wind turbine at standard operating conditions.

In another advantageous embodiment, the aerodynamic device is integrated into the trailing edge section and is directly attached to the surface of the rotor blade.

An advantage of this embodiment is that no additional components or parts have to be introduced and added to the design of the rotor blade. This embodiment is particularly advantageous if the aerodynamic device is already included in the manufacturing process of the rotor blade itself.

Connection of the aerodynamic device with the surface of the rotor blade may be done by an adhesive such as glue or by mechanical means. An adhesive has the advantage that the structure of the rotor blade which may for instance be a fibre reinforced composite material is not compromised significantly.

In another advantageous embodiment, the noise reduction means comprises a plate upon which the aerodynamic device is attached. The plate is mounted on the trailing edge section of the rotor blade.

This embodiment is particularly advantageous if a fully manufactured and finished rotor blade is equipped with the noise reduction means. This may be the case before installing the rotor blade to the hub of a wind turbine. This may also be beneficial if an existing rotor blade is retrofitted by the noise reduction means. The aerodynamic device may be attached to the plate separately and subsequently the plate with the attached noise reduction means is connected with the trailing edge section of the rotor blade.

An advantage of this procedure is that a plate may be easier to attach to the rotor blade than connecting every single aerodynamic device to the rotor blade. This may also be faster to realize than a separate connection of each aerodynamic device with the rotor blade.

In another advantageous embodiment, the noise reduction means is located upstream of a further noise reduction means. The further noise reduction means is optimized with regard to the sub-vortices which are generated by the noise reduction means. Thus, noise that is generated by interaction of the airflow and the rotor blade is further minimized.

Another advantage of the present noise reduction means is that it can be well combined with other existing noise reduction means. In other words, the generated sub-vortices which disseminate or spread out downstream of the aerodynamic device may be further manipulated by a further noise reduction means. In this case it is advantageous to adapt or optimize the further noise reduction means to the configuration, e.g. the rotational direction and the size and the speed of the sub-vortices.

An example of such a further noise reduction means is a flap, for example a serrated flap. Such a serrated flap is also referred to as a serrated panel or as a DinoTail.

If the noise reduction means is combined with a flap that is mounted on the trailing edge section, the aerodynamic device is advantageously located at the upstream section of the flap. This is advantageous as then the noise reduction potential of the flap can be fully benefitted and the aerodynamic device splits the initial large vortices of the boundary layer up, which are then further manipulated by the noise reducing feature of the flap.

In another advantageous embodiment, the aerodynamic device is located in a distance of at most 20 centimeters upstream of the trailing edge, if the trailing edge extends substantially parallel to the spanwise direction of the rotor blade. In the case that the rotor blade comprises a serrated flap and thus the trailing edge comprises the serrations of the serrated flap, the aerodynamic device is preferably located in a distance of at most 50 centimeters upstream of the tips of the serrations.

In another advantageous embodiment, the height of the aerodynamic device is at least three times larger, in particular at least five times larger, than the relative thickness of the aerodynamic device.

As it is well known to the person skilled in the art a span and a chord can be assigned to an airfoil-shaped rotor blade. The span is also referred to as the longitudinal axis of the rotor blade. It extends from the root section of the rotor blade until the tip section of the rotor blade. In a perpendicular direction of the span, chord lines of the rotor blade extend. A chord line is a straight line from the leading edge to the trailing edge of the rotor blade.

The height of the aerodynamic device may for instance be 1 centimeter. As the boundary layer and the trailing edge section are a few centimeters thick, the aerodynamic device is entirely submerged within the boundary layer. The aerodynamic device may have a chordwise dimension of a few millimeters reaching up until a few centimeters. The maximum relative thickness of the aerodynamic device however beneficially only is several tenths of a millimeter, for instance. It is beneficial to minimize the maximum relative thickness of the aerodynamic device in order to minimize the drag of the airflow within the boundary layer.

In another advantageous embodiment, a cross section of the aerodynamic device in a plane that is parallel to the chordal plane of the rotor blade comprises an airfoil shape.

The chordal plane of the rotor blade refers to the plane that is spanned by the span and the chord line at a specific radial position of the rotor blade. This means that at each radial position of the rotor blade the chordal plane may be different. In practice, however, the chordal planes may only vary slightly along the span. The fact that the aerodynamic device comprises an airfoil-shaped cross section in a top view onto the aerodynamic device has to be understood that a leading edge, a trailing edge, and even a pressure side and a suction side can be attributed to the aerodynamic device. This shape of the cross section of the aerodynamic device is proposed to optimally manipulate and break up the vortices of the boundary layer. At the same time, the impact of the aerodynamic device, for instance the drag of the aerodynamic device, is minimized.

In another advantageous embodiment, the noise reduction means comprises a plurality of aerodynamic devices which are arranged next to each other along the trailing edge. The chord lines of the airfoil-shaped aerodynamic devices are substantially parallel to each other.

In other words, the aerodynamic devices are lined up with each other, having the same orientation. An advantage of this embodiment is ease of manufacturing.

In another advantageous embodiment, the noise reduction means comprises at least one pair of aerodynamic devices with a first aerodynamic device and a second aerodynamic device. The chord line of the first aerodynamic device and the chord line of the second aerodynamic device form an angle which is in a range between 5 degrees and 90 degrees, in particular between 10 degrees and 60 degrees.

In this embodiment, the chord lines of the aerodynamic devices are not in parallel to each other, but at least one pair of aerodynamic devices show respective chord lines that are angled relative to each other. An orientation of the pair of aerodynamic devices similar to a pair of vortex generators which are known for preventing stall of the airflow at rotor blades is a beneficial alternative. The advantage of such a configuration is a possible alignment of the generated sub-vortices. By having this inclination of the two aerodynamic devices against each other vortices with a rotational axis that is substantially parallel to the airflow in this region of the rotor blade can be achieved. This has the potential of further reducing the noise that is subsequently generated at the trailing edge of the rotor blade.

In yet another advantageous embodiment, the aerodynamic device is twisted such that a chord line of the aerodynamic device at its bottom close to the surface of the rotor blade and a chord line of the aerodynamic device at its top form an angle in the range between 5 degrees and 60 degrees, in particular between 10 degrees and 45 degrees.

In other words and as an example, at the bottom part of the aerodynamic device the chord line of two adjacent aerodynamic devices may be in parallel. As with increasing height of the aerodynamic devices, the orientation of the chord line changes the configuration such that the chord lines at the top part of two adjacent aerodynamic devices form an angle between 5 degrees and 60 degrees. Thus, an inclination of the two aerodynamic devices may be achieved, which may have the potential of additional noise reduction as described above.

In another advantageous embodiment, the cross section of the aerodynamic device in a plane that is parallel to the chordal plane of the rotor blade is substantially circular.

This type of aerodynamic device is also referred to as a nail. The aerodynamic device may be orientated in a substantially perpendicular direction with regard to the surface of the rotor blade where the aerodynamic device is attached to. Such an aerodynamic device has the advantage of ease of manufacturing.

In yet another advantageous embodiment, the noise reduction means comprises a plurality of aerodynamic devices which are arranged next to each other along the trailing edge and the shape and/or orientation of the aerodynamic devices defer with regard to their spanwise position at the rotor blade.

By a variation of the aerodynamic devices in spanwise direction of the rotor blade, a local noise reduction extent can be achieved. Another effect of a spanwise variation is that for example a position close to the tip of the rotor blade may require different dimensions than another aerodynamic device that is placed more inboard of the rotor blade.

In another advantageous embodiment, spacing and distribution of the aerodynamic devices may be chosen as a regular pattern, for example a uniform spacing or they may be chosen as randomly distributed in chordwise and/or spanwise direction. Likewise regarding the height of the aerodynamic devices, a uniform height or a random distribution may be chosen.

In another advantageous embodiment, the aerodynamic device is substantially perpendicular to surface of the rotor blade at the position where the aerodynamic device is mounted on the surface of the rotor blade.

In other words, the aerodynamic device is not inclined, i.e. it is not tilted, towards the surface of the rotor blade at the trailing edge.

In yet another embodiment, the area which is covered by the aerodynamic devices in a cross section intersecting the aerodynamic devices and being perpendicular to the chordal plane of the rotor blade is between 2% and 50%.

In the following, advantageous dimensions of the aerodynamic device are given:

Preferably, the height of the aerodynamic device, i.e. its spanwise extension, is in a range between 1 millimeter and 4 centimeters.

Preferably, the length of the aerodynamic device, i.e. its chordwise extension, is in a range between 0.5 millimeters and 4 centimeters.

Preferably, the width of the aerodynamic device, i.e. its maximum relative thickness, is in a range between 0.5 millimeters and 1 centimeter.

The mentioned dimensions have been proven to be best suited for a broad range of typical, conventional rotor blades.

### BRIEF DESCRIPTION

Some of the embodiments will be described in detail, with reference to the following figures, wherein like designations denote like members, wherein:

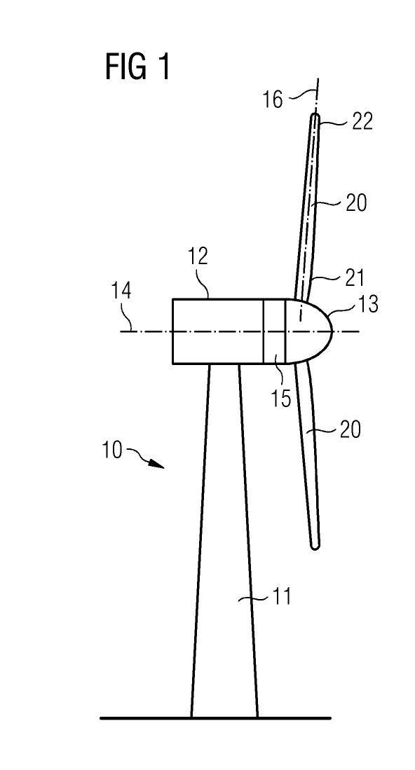

FIG. 1 shows a wind turbine;

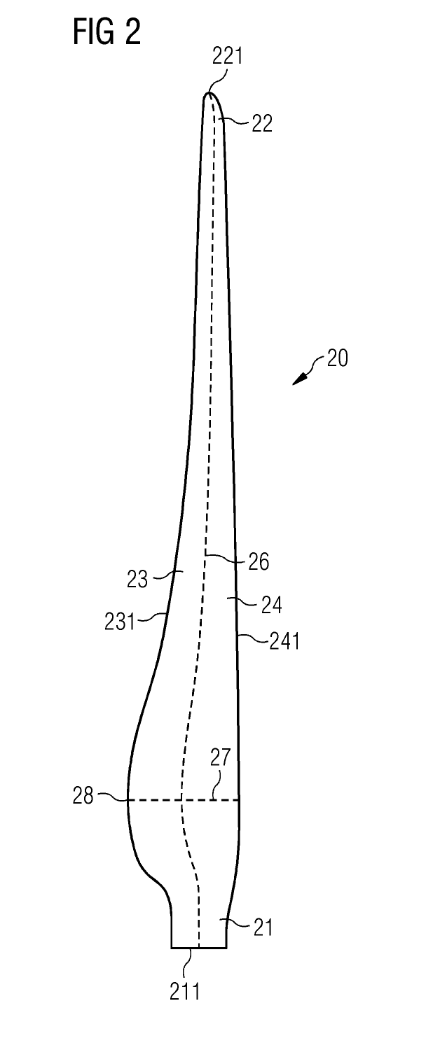

FIG. 2 shows a rotor blade of a wind turbine;

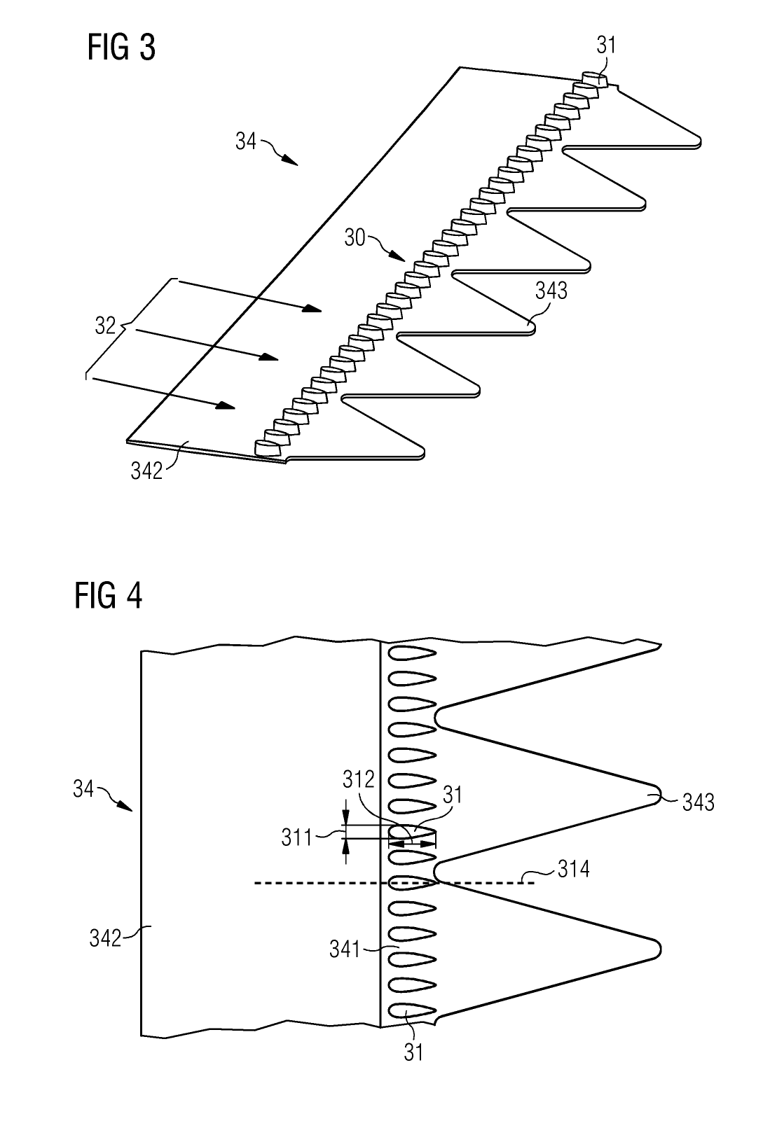

FIG. 3 shows a serrated flap equipped with a first embodiment of a noise reduction means in a perspective view;

FIG. 4 shows the first embodiment of the noise reduction means of FIG. 3 in a top view;

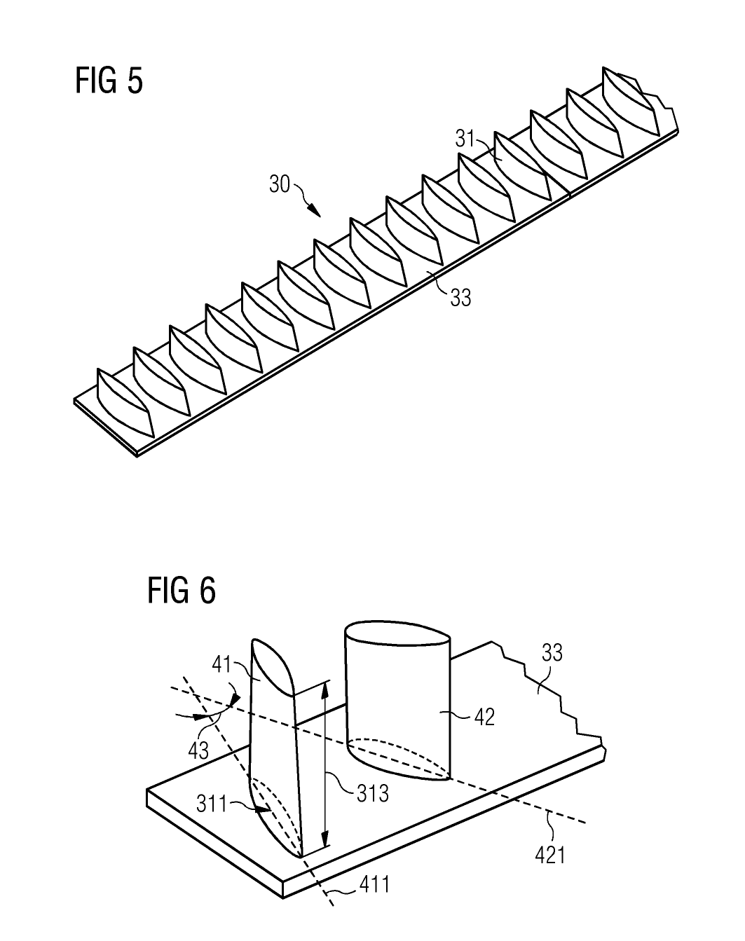

FIG. 5 shows the first embodiment of a noise reduction means mounted on a separate plate;

FIG. 6 shows a second embodiment of a noise reduction means in a perspective view;

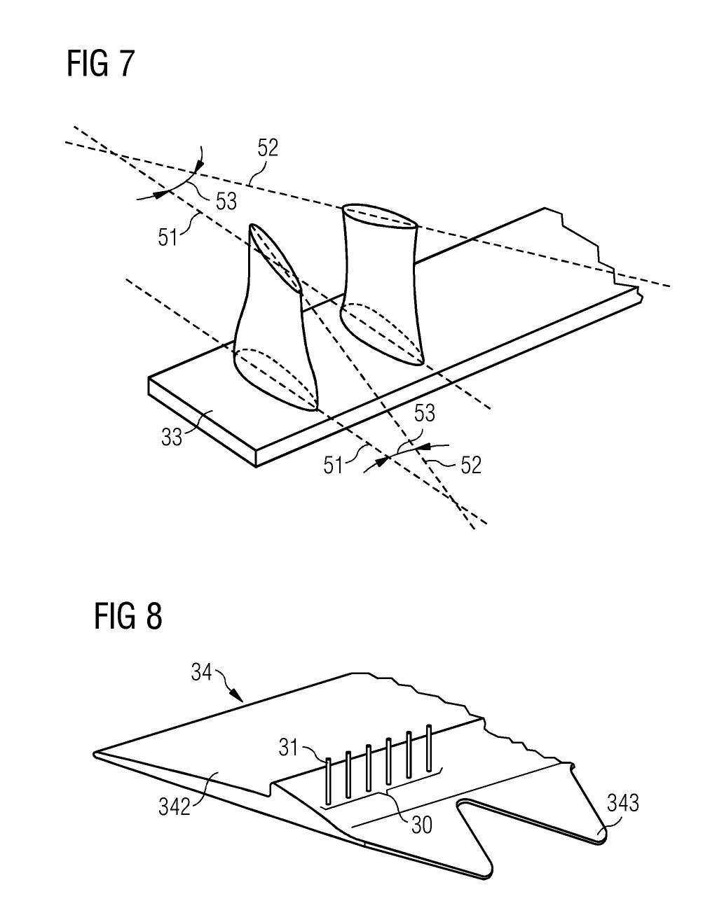

FIG. 7 shows a third embodiment of a noise reduction means in a perspective view; and

FIG. 8 shows a fourth embodiment of a noise reduction means in a perspective view.

The illustration in the drawings is in schematic form. It is noted that in different figures, similar or identical elements may be provided with the same reference signs.

### DETAILED DESCRIPTION

In FIG. 1, a wind turbine 10 is shown. The wind turbine 10 comprises a nacelle 12 and a tower 11. The nacelle 12 is mounted at the top of the tower 11. The nacelle 12 is mounted rotatable with regard to the tower 11 by means of a yaw bearing. The axis of rotation of the nacelle 12 with regard to the tower 11 is referred to as the yaw axis.

The wind turbine 10 also comprises a hub 13 with three rotor blades 20 (of which two rotor blades 20 are depicted in FIG. 1). The hub 13 is mounted rotatable with regard to the nacelle 12 by means of a main bearing. The hub 13 is mounted rotatable about a rotor axis of rotation 14.

The wind turbine 10 furthermore comprises a main shaft, which connects the hub 13 with a rotor of a generator 15. The hub 13 is connected directly to the rotor, thus the wind turbine 10 is referred to as a gearless, direct driven wind turbine. As an alternative, the hub 13 may also be connected to the rotor via a gearbox. This type of wind turbine is referred to as a geared wind turbine.

The generator 15 is accommodated within the nacelle 12. It comprises the rotor and a stator. The generator 15 is arranged and prepared for converting the rotational energy from the rotor into electrical energy.

FIG. 2 shows a rotor blade 20 of a wind turbine. The rotor blade 20 comprises a root section 21 with a root 211 and a tip section 22 with a tip 221. The root 211 and the tip 221 are virtually connected by the span 26 which follows the shape of the rotor blade 20. If the rotor blade were a rectangular shaped object, the span 26 would be a straight line. However, as the rotor blade 20 features a varying thickness, the span 26 is slightly curved or bent as well. Note that if the rotor blade 20 was bent itself, then the span 26 would be bent, too.

The rotor blade 20 furthermore comprises a leading edge section 24 with a leading edge 241 and a trailing edge section 23 with a trailing edge 231.

The trailing edge section 23 surrounds the trailing edge 231. Likewise, the leading edge section 24 surrounds the leading edge 241.

At each spanwise position, a chord line 27 which connects the leading edge 241 with the trailing edge 231 can be defined. Note that the chord line 27 is perpendicular to the span 26. The shoulder 28 is defined in the region where the chord line comprises a maximum chord length.

Furthermore, the rotor blade 20 can be divided into an inboard section which comprises the half of the rotor blade 20 adjacent to the root section 21 and an outboard section which comprises the half of the rotor blade 20 which is adjacent to the tip section 22.

FIG. 3 shows a perspective view of a first embodiment of a noise reduction means 30. The noise reduction means 30 comprises a plurality of aerodynamic devices 31. The aerodynamic devices 31 are equal in size and orientation. In other words, they are uniform and they are placed with a uniform and equal spacing between two adjacent aerodynamic devices 31. The aerodynamic devices 31 are mounted on a flap 34. The flap 34 comprises serrations 343 at the downstream section of the flap 34. The airflow 32 that is flowing from the leading edge section to the trailing edge section of the rotor blade is depicted in FIG. 3.

Thus, an upstream section and a downstream section can be attributed and assigned to the flap 34. Note that the flap comprises a connection section 342 by which the flap 34 is arranged for being mounted to a rotor blade of a wind turbine. In particular, the connection section 342 is destined for being mounted to the pressure side of the rotor blade. Finally, note that the dimensions of the aerodynamic devices 31 are small compared to the dimensions of the serrations 343.

FIG. 4 shows the first embodiment of the noise reduction means 30 that is shown in FIG. 3, this time in a top view. Again, the connection section 342, the serrations 343 and the plurality of aerodynamic devices 31 can be seen. An upstream section 341 of the flap 34 is depicted, too. The upstream section 341 is not at the left edge of the flap 34 in FIG. 4 because the trailing edge of the original rotor blade where the flap 34 is mounted to will tightly limit to the upstream section 341 of the flap 34. In other words, the connection section 342 will be connected, e.g. by an adhesive, at the pressure side of the rotor blade.

Regarding the aerodynamic devices 31, the chord line 314 of the aerodynamic device 31 and the chordwise dimension 312, as well as the maximum relative thickness 311 is depicted. It can be seen that the chordwise dimension 312 is considerably larger than the maximum relative thickness 311. Thus, drag is minimized and the initial vortices of the boundary layer are efficiently split up by the aerodynamic devices 31.

FIG. 5 shows another perspective view of the set of aerodynamic devices 31 of the first embodiment of the noise reduction means 30. In this case, the aerodynamic devices 31 are attached to a separate plate 33. This plate 33 is also referred to as the base plate. This plate 33 with the preassembled and mounted aerodynamic devices 31 can easily be connected to an existing rotor blade. This is particularly advantageous if an existing rotor blade is retrofitted. It might also be possible to upgrade and retrofit the existing rotor blade by this plate 33 with the noise reduction means 30 at an installed and mounted rotor blade. In other words, it is not necessary to de-install the rotor blade of the hub due to the ease of connection of the noise reduction means 30 with the rotor blade via the plate 33.

FIG. 6 shows a second embodiment of a noise reduction means in a perspective view. More particularly, it shows a pair of aerodynamic devices. It shows a first aerodynamic device 41 and a second aerodynamic device 42. The configuration of the two aerodynamic devices 41, 42 is similar. However, the orientation how the aerodynamic devices 41, 42 are mounted on the plate 33 differs. In particular, the chord line 411 of the first aerodynamic device 41 and the chord line 421 of the second aerodynamic device 42 form an angle 43. This angle 43 is about 30 degrees in the example shown in FIG. 6. By comparison if the two aerodynamic devices 41, 42 were substantially in parallel to each other the angle 43 would be significantly smaller or would even not exist at all.

In FIG. 6 it can also be seen that the ratio of the height 313 of the first aerodynamic device 41 and the maximum relative thickness 311 of the first aerodynamic device 41 is greater than three. This is advantageous as it optimizes the impact of the aerodynamic device to the vortices of the boundary layer while not adding significant drag to the rotor blade.

FIG. 7 shows a slightly different embodiment, namely a third embodiment of the noise reduction means in a perspective view. It shows a pair of aerodynamic devices which are twisted in respect to their vertical configuration. The chord lines of the aerodynamic devices are substantially parallel in a bottom part of the aerodynamic devices. However, due to the twist of the aerodynamic devices the chord lines at the top end of the aerodynamic devices form an angle.

In particular, the bottom chord line 51 and the top chord line 52 form an angle 53. Note that precisely a protection of the top chord line 52 onto the plain of the bottom chord line, namely the chordal plain of the bottom chord line 51 forms the angle 53. Again, if there were no twist the bottom chord line 51 and the top chord line 52 would form an angle 53 which is negligible or even non-existent at all.

Finally, FIG. 8 shows a fourth embodiment of a noise reduction means 30 in a perspective view. The noise reduction means 30 comprises a plurality of aerodynamic devices 31 which are mounted on a flap 34, in particular a serrated flap which is manifested by serrations 343. Again, the flap 34 comprises a connection section 342 which is destined to connect the flap 34 with a pressure side of a rotor blade.

The aerodynamic devices 31 have a shape of a nail. It can be said that in a top view the cross section of the aerodynamic devices 31 would have a circular shape. The aerodynamic devices 31 in FIG. 8 are uniformly distributed along the trailing edge. In another option, it may though also be beneficial to distribute the aerodynamic devices, namely the nail-shaped aerodynamic devices, differently. For example, there may be a randomly distributed chordwise distribution and/or a randomly orientated spanwise distribution of aerodynamic devices.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A rotor blade of a wind turbine, comprising:
a pressure side;
a suction side;
a leading edge section;
a trailing edge section with a trailing edge; and
a noise reduction means with at least one aerodynamic device for manipulating an airflow flowing from the leading edge section to the trailing edge section, the airflow builds up a boundary layer with vortices adjacent to a surface of the rotor blade, wherein the at least one aerodynamic device is located at the trailing edge section of the rotor blade;
wherein the at least one aerodynamic device is arranged such that the at least one aerodynamic device splits up a vortex of the boundary layer into several smaller sub-vortices to reduce noise generated by an interaction of the airflow with the rotor blade.

2. The rotor blade according to claim 1, further comprising a root section, wherein the rotor blade is arranged and prepared for being attached to a hub of the wind turbine, and a tip section, which is a section of the rotor blade that is furthest away from the root section, and the at least one aerodynamic device is connected to the rotor blade in the outer 40 per-cent, of the rotor blade adjacent to the tip section.

3. The rotor blade according to claim 1, wherein the at least one aerodynamic device is located inside the boundary layer of the airflow.

4. The rotor blade according to claim 1, wherein the at least one aerodynamic device is integrated into the trailing edge section and directly attached to the surface of the rotor blade.

5. The rotor blade according to claim 1, wherein the noise reduction means comprises a plate upon which the at least one aerodynamic device is attached, and the plate is mounted on the trailing edge section of the rotor blade.

6. The rotor blade according to claim 1, wherein the noise reduction means is located upstream of a further noise reduction means, the further noise reduction means being optimized with regard to the sub-vortices which are generated by the noise reduction means, such that noise generated by the interaction of the airflow and the rotor blade is further minimized.

7. The rotor blade according to claim 6, wherein the further noise reduction means comprises a flap.

8. The rotor blade according to claim 7, wherein the at least one aerodynamic device is located at the upstream section of the flap.

9. The rotor blade according to claim 1, wherein a height of the at least one aerodynamic device is at least three times larger than a maximum relative thickness of the at least one aerodynamic device.

10. The rotor blade according to claim 1, wherein a cross section of the at least one aerodynamic device in a plane that is parallel to a chordal plane of the rotor blade comprises an airfoil shape.

11. The rotor blade according to claim 1, wherein the noise reduction means comprises a plurality of aerodynamic devices which are arranged next to each other along the trailing edge, and the chord lines of the airfoil-shaped aerodynamic devices are substantially parallel to each other.

12. The rotor blade according to claim 1, wherein the noise reduction means comprises at least one pair of aerodynamic devices with a first aerodynamic device and a second aerodynamic device, and a chord line of the first aerodynamic device and a chord line of the second aerodynamic device form an angle which is in a range between 5 degrees and 90 degrees.

13. The rotor blade according to claim 1, wherein the at least one aerodynamic device is twisted such that a chord line of the at least one aerodynamic device at a bottom of the at least one aerodynamic device close to the surface of the rotor blade and a chord line of the at least one aerodynamic device at a top of the at least one aerodynamic device form an angle in a range between 5 degrees and 60 degrees.

14. The rotor blade according to claim 1, wherein a cross section of the at least one aerodynamic device in a plane that is parallel to a chordal plane of the rotor blade is substantially circular.

15. The rotor blade according to claim 1, wherein the noise reduction means comprises a plurality of aerodynamic devices which are arranged next to each other along the trailing edge, and a shape and/or an orientation of the plurality of aerodynamic devices differ with regard to their spanwise position at the rotor blade.

16. The rotor blade according to claim 2, wherein the at least one aerodynamic device is connected to the rotor blade in the outer 25 percent of the rotor blade adjacent to the tip section.

17. The rotor blade according to claim 7, wherein the flap is serrated.

18. The rotor blade according to claim 12, wherein the angle is in the range between 10 degrees and 60 degrees.

19. The rotor blade according to claim 13, wherein the angle is in the range between 10 degrees and 45 degrees.

20. The rotor blade according to claim 9, wherein the height of the at least one aerodynamic device is at least five times larger than the maximum relative thickness of the at least one aerodynamic device.
